(19) United States
(12) Patent Application Publication
(10) Pub. No.: US 2002/0031202 A1
(43) Pub. Date: Mar. 14, 2002

(54) X-ray scatter and transmission system with coded beams

(76) Inventors: Joseph Callerame, Lexington, MA (US); William Adams, Powell, OH (US); Lee Grodzins, Lexington, MA (US)

Correspondence Address: BROMBERG & SUNSTEIN LLP, 125 SUMMER STREET, BOSTON, MA, 02110-1618, US

(21) Appl. No.: 09/875,793

(22) Filed: Jun. 6, 2001

Related U.S. Application Data
(60) Provisional application No. 60/210,092, filed on Jun. 7, 2000.

(51) Int. Cl. G01N 23/04

(52) U.S. Cl. 378/57; 378/149; 378/86; 378/2

(57) ABSTRACT

A system and method for inspecting an object with transmitted and/or scattered penetrating radiation using either a fan beam or multiple pencil beams while maintaining resolution comparable to that achievable using a single scannable pencil beam. The system and method provide for spatial resolution of transmitted radiation using a fan beam or multiple pencil beams and a nonsegmented detector.

The present application claims priority from U.S. Provisional Application, Ser. No. 60/210,092, filed Jun. 7, 2000, which is incorporated herein by reference.

### TECHNICAL FIELD

The present invention relates to a system and method for inspecting objects, including containers and other small and large packages and enclosed spaces, using penetrating radiation, and for generating either a backscatter or transmission image, or both, of the object by other than a single scanned pencil beam.

### BACKGROUND OF THE INVENTION

X-ray systems are commonly employed for the inspection of materials or containers by illuminating the material or container with either a fan beam or a pencil beam of x-rays and detecting x-ray photons that are either transmitted through the material or scattered by the material into detectors disposed at an orientation other than directly in line with the beam. Such detectors that are not in line with the illuminating beam are referred to herein as ‘scatter’ detectors, and may include backscatter, sidescatter, or forward scatter detectors.

A fan beam may be used for illumination, typically, when only a transmission image is to be obtained. In the case of illumination by a fan beam, the spatial resolution of the image is determined primarily by the size and spacing of segmented transmission detectors. The fan beam impinges on the container, creating an irradiated swath, and the segmented detectors are then used to identify the transmissivity of each detector-sized element along the irradiated swath. This information is then used to create an image of the irradiated swath of the container. The container is then moved horizontally, and another swath is irradiated and imaged. In practice, this motion is typically continuous, with the object moving on a conveyor belt, or otherwise pulled past the x-ray system. Alternatively, the x-ray source could move at a known speed and gather equivalent information. If a pencil beam is used for illumination, segmented detectors are unnecessary, since the position of the illumination at a specified moment is known. In this case, resolution is primarily determined by the size of the pencil beam. This process typically results in lower throughput, however, since each swath through a container must now be irradiated one beam spot at a time. Thus the time required to cut a swath through the container is longer unless the beam is scanned very rapidly. However, too rapid scanning can result in a lower x-ray flux per pixel and therefore degrade any image.

A backscatter image is typically generated by scanning a pencil beam. A prior art system is shown in cross-section in FIG. 1, wherein a pencil beam 68 is scanned by a scanning wheel 74 across a container 70, shown as a truck, that is undergoing inspection. This figure is indicative of systems using both transmission and backscatter information, according to the current state of the art. Detector array 86 detects radiation transmitted through container 70 while scatter detector 82 detects radiation 80 scattered by an object 84 within the container. Note the relatively inefficient use of the available X-ray flux. Rotating chopper wheel 74 is required to produce a complete vertical scan of an entire object. Scanning of the other object dimension is accomplished by relative horizontal motion of the object and source, which is typically done either by translating the source horizontally during a scan, or by translating the object on a conveyor belt or other means. Wheel 74 rotates in a vertical plane about the axis (disposed at an angle approximately perpendicular to the plane of the paper) of a beam of energetic electrons directed toward target 72 so as to emit radiation that is absorbed by wheel 74 other than in the direction of spokes 76. Since radiation from only a single spoke 78 is incident on the inspected container 70 at any one instant of time, the source of any detected scattered radiation is known to lie along the path of beam. This allows for scatter detectors 82 to be large and to gather scattered flux 80 from a large solid angle. Positional resolution is thus achieved only by defining the region of an object 84 that is being interrogated by using a pencil beam. Irradiation either by a fan beam or by multiple, simultaneous pencil beams has been considered to be incompatible with achieving a backscatter image, for lack of an unambiguous method for determining the source of the backscatter.

### SUMMARY OF THE INVENTION

In accordance with a preferred embodiment of the present invention, there is provided a method for imaging in transmitted and/or scattered penetrating radiation using either a fan beam or multiple pencil beams, including coding each pixel-sized component of the beam; detecting the penetrating radiation after the beam interacts with the object; decoding the detected signal into a plurality of components; and uniquely associating each component of the detected signal with a particular pixel.

This process enables the user to maintain resolution comparable to that achievable using a single scannable pencil beam. The technique may advantageously utilize the X-rays emitted from an X-ray source more effectively, without the need to compromise resolution. This, in turn, increases the average flux on the target object and results in system design advantages which may allow the systems designer to either increase scan speed or improve the ability of the system to penetrate thicker or more dense objects.

In accordance with another preferred embodiment of the present invention, there is provided a method for imaging in transmitted radiation using either a fan beam or multiple pencil beams of penetrating radiation, including coding each pixel-sized component of the transmitted beam after the beam interacts with the object, detecting the transmitted radiation; decoding the detected signal into a plurality of components; and uniquely associating each component of the detected signal with a particular pixel. This process enables the user to maintain spatial resolution in the detected beam using a non-segmented detector.

### BRIEF DESCRIPTION OF THE DRAWINGS

The foregoing features of the invention will be more readily understood by reference to the following detailed description taken with the accompanying drawings:

FIG. 1 is a cross-sectional end view of a prior art x-ray scanning system using a scanned pencil beam;

FIG. 2 is a cross-sectional end view of an x-ray scanning system employing a chopper wheel of 16 spokes, with different codes assigned to each spoke irradiating the inspected object at any one instant of time, in accordance with preferred embodiments of the present invention;

FIG. 3A provides a side view in cross section of an X-ray inspection system using a fan beam, with the fan beam being divided into a large number of sections, each individually coded by a different X-ray beam modulation;

FIG. 3B shows a rotating wheel that may be used for coding individual portions of the fan beam by utilizing appropriately spaced apertures along different wheel radii, in accordance with a preferred embodiment of the invention;

FIG. 4 provides a side view in cross section of an X-ray inspection system using a fan beam, with the fan beam being divided into sections, each beam individually coded by beam modulation after the beam has traversed the object;

FIG. 5 shows a tube rotating about a linear array of detectors such that the tube may be used for coding individual portions of the fan beam after traversal of the object;

FIG. 6 shows a rotating vane modulator for use with an embodiment of the present invention; and

FIG. 7 shows a vibrating reed modulator for use with an embodiment of the present invention

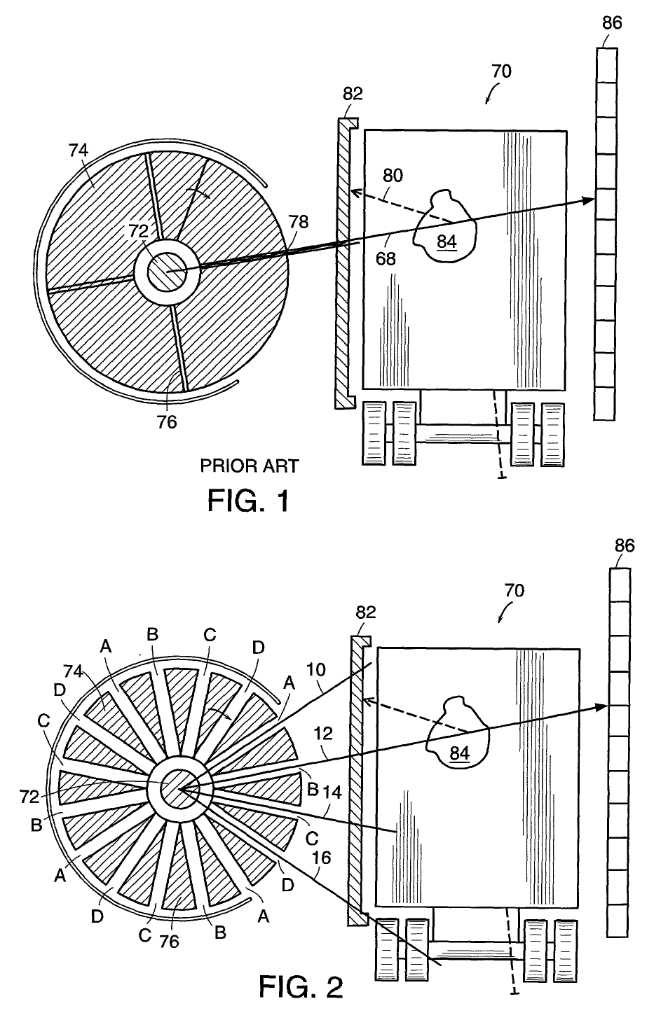

### DETAILED DESCRIPTION OF PREFERRED EMBODIMENTS

Referring now to FIG. 2, a side view of an x-ray inspection system using multiple scanned pencil beams 10, 12, 14, and 16, all incident on container 70 simultaneously, with each beam encoded with characteristic information which enables it to be distinguished from the other pencils beams. To represent types of encoding of the beams, spokes 76 of chopper wheel 74 are designated with labels A, B, C, and D, by way of example. Methods of encoding, in accordance with preferred embodiments of the invention, include, for example, different temporal modulations for each x-ray pencil beam, each beam being modulated prior to interaction with the object. These modulations may be manifested by differing characteristic modulation frequencies, selectable by electronic filtering at the transmission 86 and/or backscatter 82 detectors, or by differing reticulated patterns rotating in front of the individual pencil beams, and which could be analyzed by a suitable detection filter.

Since the beams are individually and distinguishably encoded, several sections of the object under inspection may be illuminated simultaneously, making more efficient use of the available x-ray flux. A spinning chopper wheel 74 is employed, in accordance with the embodiments described, so as to ensure that the a complete vertical scan of an entire object can be made.

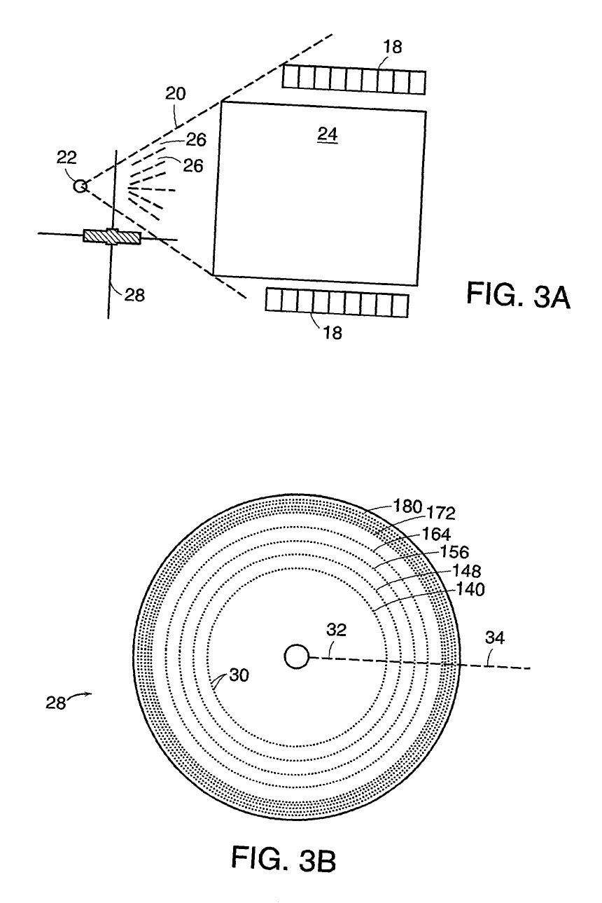

FIG. 3A provides a side view of an X-ray inspection system using a fan beam 20, emanating from x-ray source 22 and impinging upon inspected article 24. Fan beam 20 is divided into a large number of sections 26, each individually coded by a different X-ray beam modulation, as described above. The number of sections 26 may be as large as the number of pixels in the image.

One method for individually coding each section 26 of penetrating radiation is by means of rotating wheel 28 which acts as a modulator of the sections of the beam A front view of rotating wheel 28 is shown, by way of example, in FIG. 3B. In this case, a line of the object under inspection may be illuminated simultaneously. In the exemplary wheel shown in FIG. 3B, there are typically 200 rings of holes 30 in the disc, where the disc has a typical radius of ˜45 cm, and the holes have a typical diameter on the order of 1 millimeter. The rings are designated by numerals 140, 148, 156, 172, and 180 indicating the ordinal placement of the ring. Adjacent sets of rings (e.g., rings 172-180) may have the same number of holes (in this case, 176 holes) but may be distinguished on the basis of the phase of emitted radiation, since the holes of one ring are displaced with respect to the holes of another ring. By comparing the time a photon is detected by any one of detector elements 18 relative to the time of a fiducial radius 32 of disc 28 coincides with a fiducial space-fixed direction 34, the elevation of the incident photon within fan beam 26 may readily be determined. Alternatively, the rings of holes may differ in the numbers of holes per ring. The ring that the detected beam traversed may, therefore, be determined by filtering on the frequency of the detected signal.

The net result is that, at any given time, a large portion of the fan beam is being utilized to produce radiation. Because the coding process is performed by interrupting a continuous X-ray beam, the beam incident on the target at any given angle from the source varies temporally. However, this temporal variation at most reduces fan beam flux utilization by a factor of approximately two (2), whereas the coding itself has enabled the entire spatial extent of the beam to be used, increasing flux on the object by a factor of as great as one thousand (1,000) due to better spatial utilization. The net gain in flux at any given time is thus up to five hundred times (500 x) that in a pencil beam.

In alternate embodiments of the invention, the X-ray source itself may be modulated at a high frequency, well in excess of any frequency that may be used to code any individual portions of the fan beam. This source modulation may be accomplished, for example, by varying the voltage on a grid which controls the flux of electrons onto a target, prior to the generation of X-radiation, as is well known in the art. If the electron flux is modulated in this way, there will be a modulation in the electron collisions with the target, and therefore a temporal modulation of the X-ray fan beam that results from the electron collisions. Once the entire fan beam is temporally modulated at this high frequency, the lower frequency coding, on a pixel-sized basis, is impressed upon the signal, so that components of both modulating frequencies are present in each pixel-sized beam. This technique has the distinct advantage of shifting the effective coding frequency up to a much higher value, where the advantages of high frequency electronic filters, developed for other commercial applications, can be utilized. In other words, the individual pixels are now coded with frequencies that vary by different amount from a high-valued center frequency which is determined by the X-ray source grid modulation rate.

Methods for demodulating the detected signal in order to recover the spatial information with respect to the origin of the detected radiation are well known in the art. Examples include banks of filters allowing filtering of the signal at a rate corresponding to the sampling rate for respective pixels.

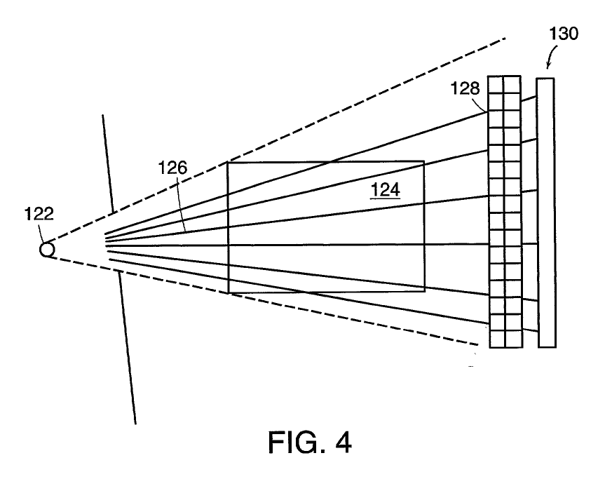

In another preferred embodiment of the present invention, an object 124 is illuminated with, for example, a fan beam 126 emanating from an x-ray source 122, as shown in FIG. 4. A beam coder 128 is placed between the object 124 and a detector 130. Each pixel-sized component of the beam is detected after interaction with the object 124. The beam coding allows each component of the detected signal to be associated with a pixel. This embodiment of the invention can advantageously reduce the complexity of the required detector.

Methods of encoding the beam include applying different temporal modulations for each portion of the transmitted beam after the beam has traversed the object. These modulations may be manifested by different characteristic modulation frequencies, selectable at the transmission detector or by differing reticulated patterns positioned in front of the beam, which could be analyzed by a suitable detection filter.

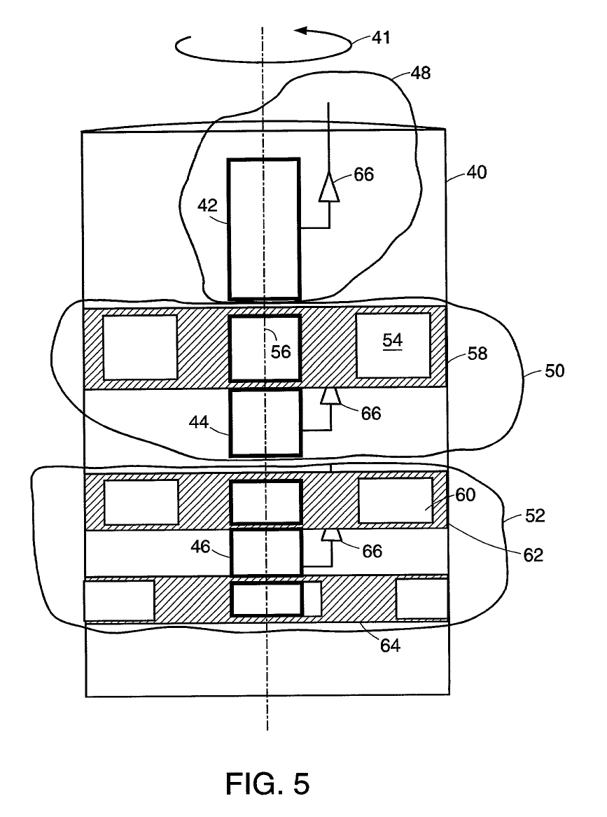

For example, FIG. 5 shows a linear detector array 66 that is surrounded by a tube 40. The tube's thickness is, for example, a 1/e absorption length for the x-rays The tube 40 rotates at, for example, 1800 rpm about its axis 41. If the tube is open, as in section 48, the signal is not modulated and the detector 42 resolution is its width x height. For section 50, a band 58 covers the top half of the detector 44. Band 58 has, for example, 10 openings, 54, only three of which are shown As the tube rotates, x-rays that are directed towards the lower half of the detector 44 are continuously counted. X-rays directed toward the upper half of the detector 44 are detected 50% of the time with a modularity of 10 pulses per revolution. The signal from detector 44 has a DC component from the lower half and a modulated signal from the upper half. The effective vertical resolution is a factor of two better than without the modulator 58. Section 52 contains two bands, 62 and 64, so that the response from detector 46 has 3 components: a DC component from the middle section; a 10 pulses per revolution component from the upper third 62 that contains 10 openings 60 and a 7 pulses per revolution component from the lower third 64. These components are readily separated in the processing of the signal. The effective vertical resolution is a factor of 3 better than without the modulator 52. The number of detectors in the detector array and the pattern of slots in the tube walls may be varied to achieve a desired spatial resolution for the image.

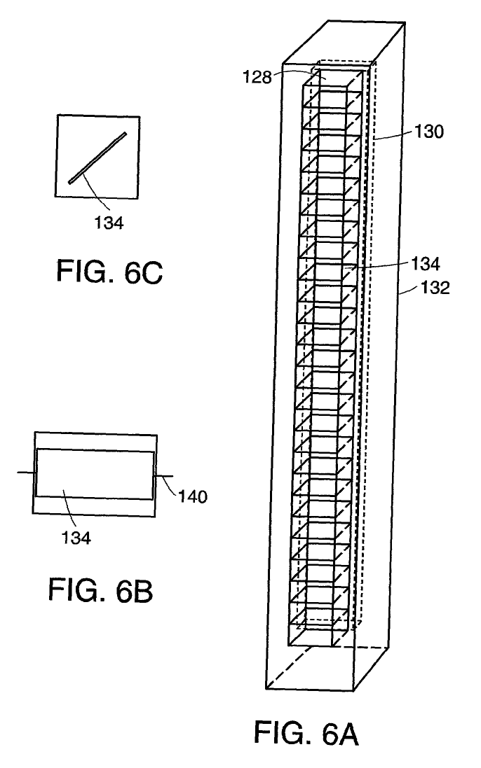

FIG. 6A shows a further example of a beam coder for use with the embodiment of the present invention shown in FIG. 4. A segmented collimator 128 comprising absorbing separators 134 used as a beam coder is placed in front of a scintillator 130 that is used as a detector. The collimator and scintillator are enclosed in a housing 132. Each separator 134 has an x-ray absorbing material that is alternately placed so as to block an x-ray beam or allow the beam to pass through the collimator 128 to the scintillator 130 detector. FIG. 6B shows a front view of a rotating vane 134 that can be used as a separator. Each rotating vane 134 is driven by a drive axle 140. Each rotating vane 134 is driven at a different frequency. The beam that has passed through each separator can be uniquely identified by electronically separating the frequency components of the signal produced by the scintillator 130 detector.

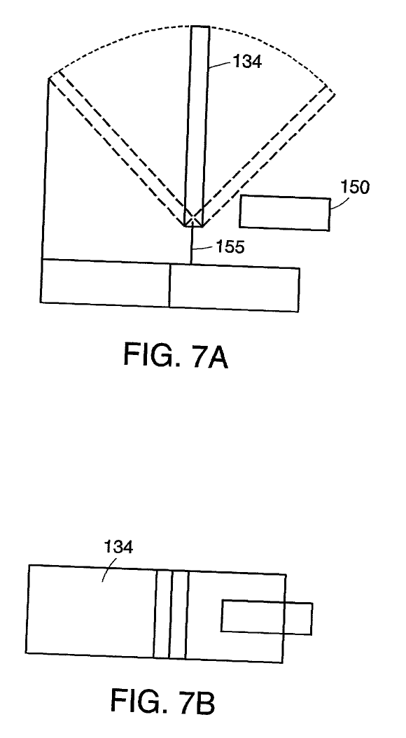

FIG. 7A shows another example of a beam coder for use with the embodiment of the present invention shown in FIG. 4. FIG. 7A is a top view of a vibrating reed separator 134 that is made of x-ray blocking material. The reed 134 is mounted so that it vibrates back and forth, alternately blocking and then opening a collimator 128 segment. The vibration is excited, for example, by an electrical drive solenoid 150 driven at the resonant frequency of the mechanical assembly with a leaf spring 155 used to provide a restoring force. Each vibrating reed 134 is resonant and driven at a different frequency. FIG. 7B shows a front view of the vibrating reed separator 134. The beam that has passed through each vibrating reed separator 134 can be uniquely identified by electronically separating the frequency components of the signal produced by the scintillator 130 detector.

While the invention has been described in detail, it is to be clearly understood that the same is by way of illustration and example and is not to be taken by way of limitation. Indeed, numerous variations and modifications will be apparent to those skilled in the art. All such variations and modifications are intended to be within the scope of the present invention as defined in the appended claims.

We claim:

1. An inspection device for inspecting an object, the inspection device comprising:
a. a source of penetrating radiation for irradiating the object at a plurality of positions;
b. at least one detector for detecting the penetrating radiation after interaction with the object;
c. a modulator for modulating the incident penetrating radiation in such a manner as to characterize the position of irradiation; and
d. a processor for deriving the position of irradiation giving rise to the penetrating radiation detected by the at least one detector.

2. An inspection device according to claim 1, wherein the modulator includes a rotating wheel with concentric rings of holes.

3. An inspection system according to claim 1, wherein the penetrating radiation is x-ray radiation.

4. An inspection device according to claim 3, wherein the modulator modulates x-ray source emissions at a frequency higher than any pixel coding.

5. An inspection device for inspecting an object, the inspection device comprising:
a. a source of penetrating radiation for irradiating the object with a plurality of beams;
b. a modulation system for coding each of the beams with a distinct temporal pattern of intensity variation in such a manner that by decoding the detected signal, a signal component may be uniquely associated with each of the plurality of beams.
c. at least one detector for detecting the penetrating radiation after interaction with the object;
d. a processor for deriving the position of irradiation giving rise to the penetrating radiation detected by the at least one detector.

6. An inspection device according to claim 5, wherein the modulation system includes a rotating wheel with concentric rings of holes.

7. An inspection system according to claim 5, wherein the penetrating radiation is x-ray radiation.

8. An inspection device according to claim 7, wherein the modulation system modulates x-ray source emissions at a frequency higher than any pixel coding.

9. A method for illuminating an object with a beam of penetrating radiation, the beam having a specified cross-section, the method comprising:
a. coding each pixel-sized component of the beam;
b. detecting the penetrating radiation after interaction with the object in such a manner as to produce a signal; and
c. decoding the detected signal into a plurality of components; and
d. uniquely associating each component of the detected signal with one particular pixel.

10. A method according to claim 10, further including modulating emission of the beam at a frequency higher than any pixel coding of the beam.

11. An inspection device for inspecting an object, the inspection device comprising:
a. a source of penetrating radiation for irradiating the object with a beam;
b. a modulation system for coding the beam after transmission through the object with a distinct temporal pattern of intensity variation in such a manner that by decoding the detected signal, a signal component may be uniquely associated with the modulated portion of the beam.
c. at least one detector for detecting the penetrating radiation after interaction with the object;
d. a processor for deriving the position of irradiation giving rise to the penetrating radiation detected by the at least one detector.

12. An inspection device according to claim 11, wherein the modulation system includes a rotating tube including concentric rings of slots.

13. An inspection device according to claim 11, wherein the modulation system includes a rotating vane.

14. An inspection device according to claim 11, wherein the modulation system includes a vibrating reed.

15. An inspection system according to claim 11, wherein the penetrating radiation is x-ray radiation.

16. A method for illuminating an object with a beam of penetrating radiation, the beam having a specified cross-section, the method comprising:
a. coding each pixel-sized component of the beam after traversing the object;
b. detecting the penetrating radiation after interaction with the object in such a manner as to produce a signal; and
c. decoding the detected signal into a plurality of components; and
d. uniquely associating each component of the detected signal with one particular pixel.

17. A method according to claim 16, further including modulating emission of the beam at a frequency higher than any pixel coding of the beam.
